(19) United States
(12) Patent Application Publication
(10) Pub. No.: US 2025/0343308 A1
(43) Pub. Date: Nov. 6, 2025

(54) BATTERY MODULE AND ELECTRIC DEVICE

(71) Applicant: XIAMEN AMPACK TECHNOLOGY LIMITED, Xiamen (CN)

(72) Inventors: Fanggui PENG, Xiamen (CN); Dian YANG, Xiamen (CN); Ning ZHU, Xiamen (CN)

(73) Assignee: XIAMEN AMPACK TECHNOLOGY LIMITED, Xiamen (CN)

(21) Appl. No.: 19/272,288

(22) Filed: Jul. 17, 2025

Related U.S. Application Data
(63) Continuation of application No. PCT/CN2023/072726, filed on Jan. 17, 2023.

(51) Int. Cl. H01M 50/204; H01M 10/6551; H01M 10/658

(52) U.S. Cl. CPC H01M 50/204; H01M 10/6551; H01M 10/658

(57) ABSTRACT

A battery module includes a housing, a cell assembly, and a heat sink. The housing includes a first housing and a second housing. The first housing forms a first space. The first housing includes a first wall, a second wall, and a bottom wall. The cell assembly is accommodated in the first space. The heat sink is disposed in the first space, the heat sink, the first housing, the second housing form a second space. Along a first direction, the cell assembly is located between the heat sink and the bottom wall. At least one of the first wall or the second wall is provided with a first channel. The first space is in communication with the second space through the first channel. The first housing is provided with a first through hole in communication with the first space and an exterior.

### CROSS REFERENCE TO THE RELATED APPLICATIONS

This application is a continuation application of International Application No. PCT/CN2023/072726, filed on Jan. 17, 2023, the content of which is incorporated herein by reference in its entirety.

### TECHNICAL FIELD

The present application relates to the field of energy storage technology, and more particularly, to a battery module and an electric device.

### BACKGROUND

Battery modules are currently widely used in fields such as drones, electric vehicles, and intelligent energy storage devices. When liquid intrudes into the interior of a battery module, current battery modules have difficulty draining the liquid from the battery module. The prolonged presence of liquid inside the battery module can easily cause a short circuit, affecting the safety of the battery module.

### SUMMARY

In view of this, it is necessary to provide a battery module and an electric device capable of draining liquid, reducing the risk of short circuits, and improving the safety of the battery module.

An embodiment of the present application provides a battery module, including a housing, a cell assembly, and a heat sink. The housing includes a first housing and a second housing. The first housing is connected to the second housing. The first housing forms a first space. The first housing includes a first wall, a second wall, and a bottom wall, where the first wall and the second wall are connected to the bottom wall. The cell assembly is accommodated in the first space. The heat sink is disposed in the first space, and the heat sink, the first housing, and the second housing form a second space. Along a first direction, the cell assembly is located between the heat sink and the bottom wall. At least one of the first wall or the second wall is provided with a first channel. The first space is in communication with the second space through the first channel. The first housing is provided with a first through hole in communication with the first space and an exterior. By providing the first channel and the first through hole in the first housing, the first channel connects the first space and the second space, allowing liquid in the second space to flow through the first channel to the first space and be discharged from the battery module through the first through hole, reducing the risk of short circuits caused by liquid inside the battery module and improving the safety of the battery module.

Optionally, in some embodiments of the present application, the battery module further includes a first filling member. The first filling member is detachably disposed in the first through hole and can unblock or seal the first through hole.

Optionally, in some embodiments of the present application, the first filling member is connected to the first housing. A first gap is provided between the first filling member and the first through hole. The first gap allows gas and water in the first space and the second space to be discharged, balancing the air pressure in the first space and the second space, and the first gap can also restrict liquid from entering the first space through the first through hole.

Optionally, in some embodiments of the present application, the first through hole is disposed in the bottom wall, facilitating liquid drainage when the battery module is positioned or moving.

Optionally, in some embodiments of the present application, the first housing includes a third wall and a fourth wall disposed along a second direction. The first wall and the second wall are disposed along a third direction. The first wall is connected to the third wall and the fourth wall, and the second wall is connected to the third wall and the fourth wall. The first wall, the second wall, the third wall, and the fourth wall are connected to the bottom wall and form the first space. The heat sink is sealingly connected to surfaces of the first wall, the second wall, the third wall, and the fourth wall, enhancing the connection strength between the heat sink and the first housing 11 and improving the sealing performance of the connection between the heat sink and the first housing, which facilitates the sealed separation of the first space and the second space. The third direction is perpendicular to both the second direction and the first direction.

Optionally, in some embodiments of the present application, the heat sink is bonded to surfaces of the first wall, surfaces of the second wall, surfaces of the third wall, and surfaces of the fourth wall, further facilitating the sealed connection between the heat sink and the surfaces of the first wall, the second wall, the third wall, and the fourth wall.

Optionally, in some embodiments of the present application, the first wall has a first wall region. The first wall region is provided with a first housing insulator. The first housing insulator is disposed between the first wall region and a first sidewall. The first housing insulator closely fits the first wall region and the first sidewall, further increasing the sealing performance of the connection between the first sidewall and the first wall, which further facilitates the sealed separation of the first space and the second space.

Optionally, in some embodiments of the present application, the second wall has a second wall region. The second wall region is provided with a second housing insulator. The second housing insulator is located between the second wall region and a second sidewall. The second housing insulator closely fits the second wall region and the second sidewall, further increasing the sealing performance of the connection between the second sidewall and the second wall, which further facilitates the sealed separation of the first space and the second space.

Optionally, in some embodiments of the present application, a third sidewall is provided with a third housing insulator. The third housing insulator is disposed between the third sidewall and the third wall, further increasing the sealing performance of the connection between the third sidewall and the third wall, which further facilitates the sealed separation of the first space and the second space.

Optionally, in some embodiments of the present application, a fourth housing insulator is disposed between a fourth sidewall and the fourth wall, further increasing the sealing performance of the connection between the fourth sidewall and the fourth wall, which further facilitates the sealed separation of the first space and the second space.

Optionally, in some embodiments of the present application, the first through hole is disposed in at least one of the first wall, the second wall, the third wall, and the fourth wall, facilitating liquid drainage from multiple directions.

Optionally, in some embodiments of the present application, the first channel includes a first opening facing the second housing. The heat sink includes a first surface and a second surface disposed along the first direction. The second surface faces the cell assembly. Along a direction opposite to the first direction, the position of the first opening does not exceed the first surface, facilitating the entry of liquid in the second space into the first channel and aiding liquid drainage.

Optionally, in some embodiments of the present application, along a direction opposite to the first direction, the position of the first opening is lower than the first surface, further facilitating liquid drainage.

Optionally, in some embodiments of the present application, the first channel includes a first segment and a second segment in communication along the first direction. The first segment includes a first end and a second end disposed along the first direction. The second end is in communication with the second segment. The first opening is disposed at the first end. Along the second direction, a width W1 of the first segment is smaller than a width W2 of the second segment. By reducing the width of the first segment, the risk of the second insulator blocking the first segment and preventing liquid drainage can be further reduced. By increasing the width of the second segment, liquid outflow is facilitated, improving liquid drainage efficiency and reducing the weight of the second wall, thereby lightening the battery module.

Optionally, in some embodiments of the present application, the battery module further includes a first insulator. At least a part of the first insulator is disposed in a second gap between the heat sink and the cell assembly. Along the first direction, the second end protrudes beyond the first insulator, helping to reduce the entry of the first insulator into the first segment from the second end.

Optionally, in some embodiments of the present application, the second segment is spaced apart from the first insulator, helping to reduce the entry of the first insulator into the first segment from the second end.

Optionally, in some embodiments of the present application, along the third direction, the first channel includes a second opening facing the heat sink. The battery module further includes a first separator. The first separator covers at least a part of the second opening. Along the first direction, an end portion of the first separator protrudes beyond the first insulator, reducing the entry of insulating material of the first insulator 50 into the first channel.

Optionally, in some embodiments of the present application, the first separator includes a first side and a second side disposed along the first direction. Along the first direction, the first side is not lower than the second surface, and the second side protrudes beyond the first insulator, reducing the entry of insulating material of the first insulator into the first channel.

Optionally, in some embodiments of the present application, along the first direction, the first side is disposed at the first end. The position of the first side is lower than the first surface and higher than the second surface. The second side protrudes beyond the first insulator, reducing the entry of a flowable first insulating material into the first segment during inverted filling of the flowable first insulating material, thereby lowering the risk of the first segment being blocked and preventing liquid drainage.

Optionally, in some embodiments of the present application, the first housing includes two opposing step surfaces. The first separator is connected to the two step surfaces and covers at least a part of the first segment, facilitating the connection of the first separator to the first housing.

Optionally, in some embodiments of the present application, the second wall is provided with a second wall region. Along the third direction, a surface of the first separator is flush with a surface of the second wall region, the surface of the first separator being a surface facing away from the step surfaces. A surface of the first separator is connected to the second sidewall of the heat sink, the surface of the first separator being a surface facing away from the step surfaces, increasing the sealing performance between the first separator and the second sidewall.

Optionally, in some embodiments of the present application, optionally, the second wall is provided with a second wall region. Along the third direction, a surface of the first separator protrudes beyond a surface of the second wall region, the surface of the first separator being a surface facing away from the step surfaces. A surface of the first separator is connected to the second sidewall of the heat sink, the surface of the first separator being a surface facing away from the step surfaces allowing the first separator and the second sidewall, as well as the first separator and the step surfaces, to be compressively connected, further increasing the sealing performance between the first separator and the second sidewall.

Optionally, in some embodiments of the present application, one side of the first separator is connected to the step surfaces, and another side is connected to the heat sink, increasing the sealing performance between the first separator and the heat sink.

Optionally, in some embodiments of the present application, one side of the first separator disposed along the third direction is bonded to the step surfaces, and another side is bonded to the second sidewall of the heat sink, further increasing the sealing performance between the first separator and the second sidewall.

Optionally, in some embodiments of the present application, the heat sink includes a second accommodation space. The second accommodation space penetrates the heat sink along the first direction. The battery module further includes a second insulator. The second insulator is disposed in the second accommodation space and protrudes beyond the first surface. The first channel further includes a third segment. The third segment and the first segment are in communication through the first opening. A part of the second insulator is disposed in the third segment, and the second insulator is spaced apart from the first opening. The third segment can accommodate a part of the second insulator overflowing from the second accommodation space, reducing the risk of the second insulator blocking the first segment and preventing liquid drainage.

Optionally, in some embodiments of the present application, the battery module further includes a first electrical connection portion. The first electrical connection portion is connected to the cell assembly, and the first electrical connection portion passes through the second accommodation space.

Optionally, in some embodiments of the present application, the second insulator is disposed in the second accommodation space, insulating and fixing the first electrical connection portion. The second insulator protrudes beyond the first surface, reducing the possibility of liquid entering the second accommodation space, minimizing liquid accumulation in the second accommodation space, and facilitating the discharge of liquid from the battery module.

Optionally, in some embodiments of the present application, the heat sink includes a first accommodation space. The first accommodation space penetrates the heat sink along the first direction. The second insulator is disposed in the first accommodation space. The second insulator protrudes beyond the first surface, reducing the possibility of liquid entering the first accommodation space, minimizing liquid accumulation in the first accommodation space, and facilitating the discharge of liquid from the battery module.

Optionally, in some embodiments of the present application, the heat sink includes a third accommodation space. The third accommodation space penetrates the heat sink along the first direction. A second electrical connection portion passes through an insulating bracket and the third accommodation space and is connected to a second connection portion. The second insulator is disposed in the third accommodation space, insulating and fixing the second electrical connection portion. The second insulator protrudes beyond the first surface, reducing the possibility of liquid entering the third accommodation space, minimizing liquid accumulation in the third accommodation space, and facilitating the discharge of liquid from the battery module.

Optionally, in some embodiments of the present application, along the second direction, a width of the third segment is greater than a width of the first segment. By increasing the width of the third segment, more of the second insulator can be accommodated, and by reducing the width of the first segment, the risk of the second insulator blocking the first segment and preventing liquid drainage can be further reduced.

Optionally, in some embodiments of the present application, the first segment includes a first region and a second region. The first region is connected to the third segment. The second region is connected to the first region and the second segment. Along the third direction, a distance between the first region and the first separator is smaller than a distance between the second region and the first separator, further reducing the entry of the second insulator into the first segment from the first opening, thereby further lowering the risk of the second insulator blocking the first segment and preventing liquid drainage.

Optionally, in some embodiments of the present application, the bottom wall includes a third region. The third region is connected to the first through hole. The third region is provided with an inclined surface. The inclined surface is arranged to converge toward the first through hole, allowing liquid to collect toward the first through hole, facilitating improved liquid drainage efficiency.

Optionally, in some embodiments of the present application, the bottom wall includes a fourth region. At least a part of the cell assembly is disposed in the fourth region. Along the first direction, the third region is farther from the cell assembly than the fourth region. The fourth region can reduce the overflow of liquid from the third region to other regions of the bottom wall.

Optionally, in some embodiments of the present application, the first housing includes a first connecting member connected to the bottom wall. The first connecting member includes a support portion. The bottom wall is disposed on the support portion. The first connecting member is provided with a second through hole. The second through hole penetrates the first connecting member along the first direction. A part of the first filling member is disposed in the second through hole, reducing the entry of liquid into the battery module through the first through hole.

Optionally, in some embodiments of the present application, the first connecting member includes a bottom surface. The bottom surface faces away from the bottom wall. Along the first direction, a third space is provided between the first filling member and the bottom surface. The third space allows the first filling member to be distanced from a placement surface, preventing direct contact between the first filling member and liquid on the placement surface, reducing liquid erosion of the first filling member and minimizing the entry of liquid into the battery module through the first through hole.

Optionally, in some embodiments of the present application, the first insulator is connected to inner surfaces of the first wall, the second wall, the third wall, and the fourth wall, further facilitating the sealed separation of the first space and the second space.

Optionally, in some embodiments of the present application, the first insulator is configured to be formed by curing a flowable insulating material disposed in the battery module, facilitating the injection of the first insulator.

An embodiment of the present application further provides an electric device, including the battery module according to any one of the foregoing embodiments.

The above-described battery module and electric device, by providing the first channel and the first through hole in the first housing, where the first channel connects the first space and the second space, allow liquid in the second space to flow through the first channel to the first space and be discharged from the battery module through the first through hole, reducing the risk of short circuits caused by liquid inside the battery module and improving the safety of the battery module.

### BRIEF DESCRIPTION OF DRAWINGS

FIG. 1 shows a structural schematic diagram of a battery module in some embodiments.

FIG. 2 shows a structural schematic diagram of a battery module from another perspective in some embodiments.

FIG. 3 shows a structural schematic diagram of a battery module from yet another perspective in some embodiments.

FIG. 4 shows a structural schematic diagram of a battery module from a further perspective in some embodiments.

FIG. 5 shows a cross-sectional schematic diagram along III-III in FIG. 3.

FIG. 6 shows a partial exploded structural schematic diagram of a battery module in some embodiments.

FIG. 7 shows a cross-sectional view of the battery module along IV-IV in FIG. 1.

FIG. 8 shows a structural schematic diagram of a heat sink in some embodiments.

FIG. 9 shows a structural schematic diagram of a second wall and a bottom wall in some embodiments.

FIG. 10 shows a structural schematic diagram of a single cell in some embodiments.

FIG. 11 shows an exploded schematic diagram of a single cell in some embodiments.

FIG. 12 shows a partial structural schematic diagram of a battery module in some embodiments.

FIG. 13 shows an exploded schematic diagram of FIG. 12.

FIG. 14 shows a cross-sectional view of the battery module along II-II in FIG. 1.

FIG. 15 shows a structural schematic diagram of a second wall in some embodiments.

FIG. 16 shows a structural schematic diagram of a second wall and a first separator in some embodiments.

FIG. 17 shows a structural schematic diagram of a second wall from another perspective in some embodiments.

FIG. 18 shows a structural schematic diagram of a second wall and a first separator from another perspective in some embodiments.

FIG. 19 shows a structural schematic diagram of a battery module with a second wall removed in some embodiments.

FIG. 20 shows a structural schematic diagram of a bottom wall in some embodiments.

FIG. 21 shows a structural schematic diagram of a bottom wall and a first through hole in some embodiments.

FIG. 22 shows a structural schematic diagram of a second housing and a second circuit board in some embodiments.

FIG. 23 shows a structural schematic diagram of an electric device in some embodiments.

Reference signs of main components:

| | |
|---|---|
| Battery module | 100 |
| Housing | 10 |
| First opening | 10a |
| Second opening | 10b |
| First housing | 11 |
| First channel | 11a |
| First segment | 110 |
| First end | 110a |
| Second end | 110b |
| First opening | 1101 |
| Step surface | 1102 |
| First region | 1103 |
| Second region | 1104 |
| Second segment | 120 |
| Third segment | 130 |
| First through hole | 11b |
| Second opening | 111b |
| First channel sidewall | 112b |
| First wall | 111 |
| First wall region | 111a |
| First housing insulator | 1110 |
| Third connecting hole | 1111 |
| Second wall | 112 |
| Second wall region | 112a |
| Second housing insulator | 1120 |
| Fourth connecting hole | 1121 |
| Third wall | 113 |
| Seventh connecting hole | 1131 |
| Fourth wall | 114 |
| Eighth connecting hole | 1141 |
| Bottom wall | 115 |
| Third region | 115a |
| Inclined surface | 1151 |
| Fourth region | 115b |
| First limiting member | 115c |
| First limiting portion | 1152 |
| Second limiting portion | 1153 |
| Third limiting portion | 1154 |
| First connecting member | 116 |
| Support portion | 1161 |
| Bottom surface | 116a |
| Second through hole | 116b |
| First space | 101 |
| Second space | 102 |
| Third space | 116c |
| First fastener | 103 |
| Second fastener | 104 |
| Third fastener | 105 |
| Fourth fastener | 106 |
| Second housing | 12 |
| Second housing recess | 12a |
| Second circuit board | 13 |
| First connection portion | 131 |
| Second connection portion | 132 |
| Connecting bracket | 14 |
| Bracket through hole | 141 |
| Cell assembly | 20 |
| Cell | 21 |
| Cell housing | 211 |
| First shell | 2111 |
| Second shell | 2112 |
| First extension portion | 2113 |
| Second extension portion | 2114 |
| First sealing portion | 2115 |
| Second sealing portion | 2116 |
| First portion | 211a |
| Second portion | 211b |
| First recess | 211c |
| Electrode assembly | 212 |
| Electrode terminal | 213 |
| Welding portion | 213a |
| First end | 2131 |
| First terminal | 213b |
| Second terminal | 213c |
| First row of cells | 21a |
| Second row of cells | 21b |
| Heat dissipating portion | 22 |
| First elastic member | 221a |
| Heat sink | 30 |
| First sidewall | 30a |
| First connecting hole | 301 |
| Second sidewall | 30b |
| Second connecting hole | 302 |
| Third sidewall | 30c |
| Fifth connecting hole | 303 |
| Fourth sidewall | 30d |
| Sixth connecting hole | 304 |
| First surface | 30e |
| Second surface | 30f |
| Second channel | 30j |
| First accommodation space | 31 |
| Second accommodation space | 32 |
| Third accommodation space | 33 |
| First filling member | 40 |
| First gap | 40a |
| First insulator | 50 |
| Second gap | 50a |
| First circuit board | 60 |
| First conductive sheet | 61 |
| Insulating bracket | 70 |
| Second insulator | 80 |
| Third insulator | 81 |
| Fourth insulator | 82 |
| First separator | 90 |
| First side | 91 |
| Second side | 92 |
| Sampling wire harness | 100a |
| First electrical connection portion | 100b |
| Second electrical connection portion | 100c |
| Electric device | 200 |
| First direction | X |
| Second direction | Y |
| Third direction | Z |

The following specific embodiments will further illustrate the present application in conjunction with the above drawings.

### DESCRIPTION OF EMBODIMENTS

The following specific some embodiments are exemplary and not restrictive, aiming to provide a basic understanding of the present application but not to confirm critical or decisive elements of the present application and not to limit the scope of protection. As long as there is no structural conflict, the various technical features mentioned in various embodiments can be combined in any manner.

When one component is assumed to be “disposed at/on/in” another component, the component may be provided directly at/on/in the another component or with a component possibly present therebetween. When one component is assumed to be “connected to” another component, it may be connected to the another component directly or with a component possibly present therebetween.

It should be understood that the terms “perpendicular” and “equal to” are used to describe an ideal state of two components. During actual production or use, an approximately perpendicular or equal state may be present between the two components. For example, with reference to the description of numerical values, “perpendicular” may indicate that an included angle between two straight lines is within a range of 90°±10°, “perpendicular” may alternatively indicate that a dihedral angle of two planes is within a range of 90°±10°, and “perpendicular” may further alternatively indicate that an included angle between a straight line and a plane is within a range of 90°±10°. Two components described as “perpendicular” to each other may not be absolutely straight lines or planes, and may be approximately straight lines or planes. From a macro perspective, a component can be considered as a “straight line” or “plane” as long as the overall extension direction is a straight line or a plane.

The term “parallel” is used to describe an ideal state of two components. During actual production or use, an approximately parallel state may be present between the two components. For example, with reference to the description of numerical values, “parallel” may indicate that an included angle between two straight lines is within a range of 180°=10°, “parallel” may alternatively indicate that a dihedral angle of two planes is within a range of 180°=10°, and “parallel” may further alternatively indicate that an included angle between a straight line and a plane is within a range of 180°±10°. Two components described as “parallel” to each other may not be absolutely straight lines or planes, and may be approximately straight lines or planes. From a macro perspective, a component can be considered as a “straight line” or “plane” as long as the overall extension direction is a straight line or a plane.

Unless otherwise defined, the term “a plurality of” in the specification specifically indicates that there are two or more components when used to describe the number of components.

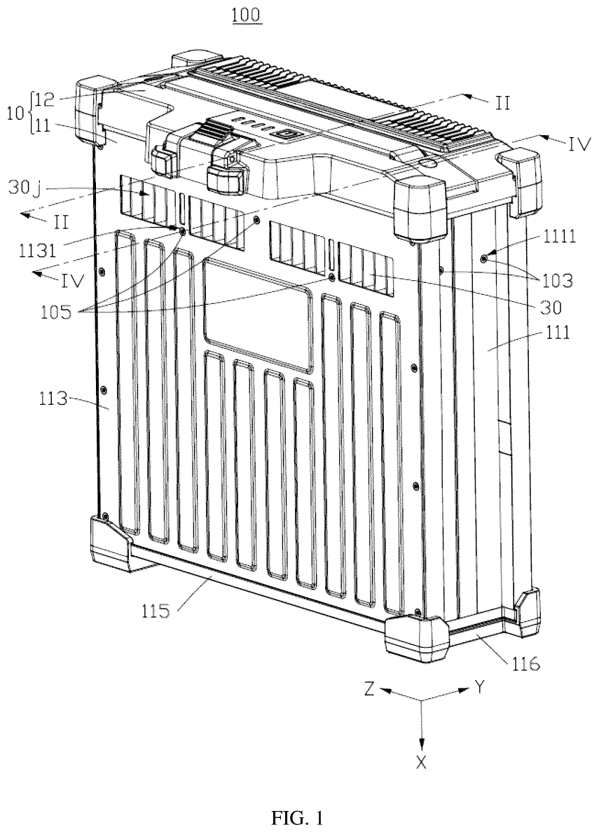

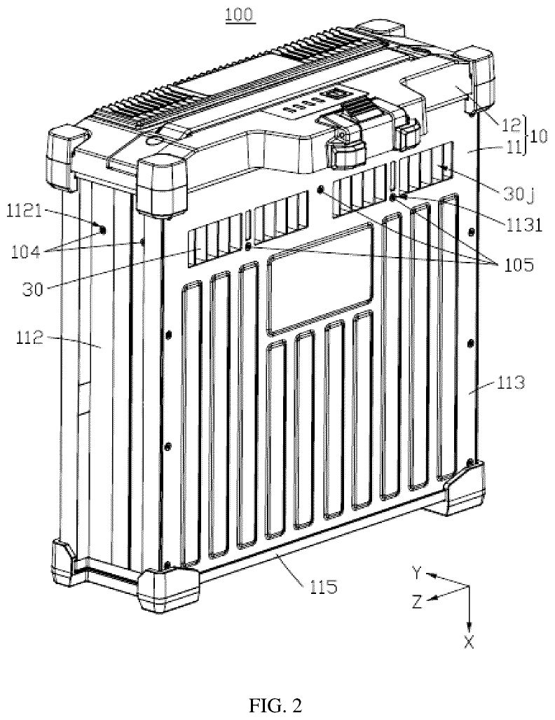

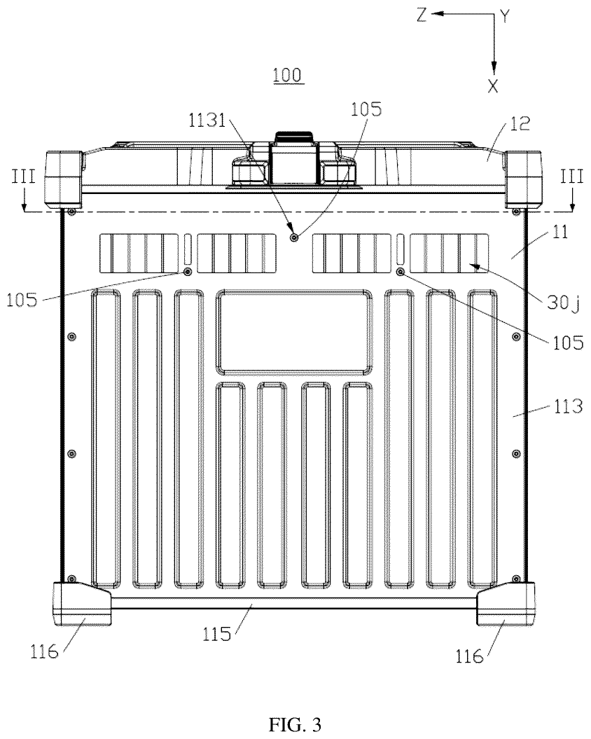

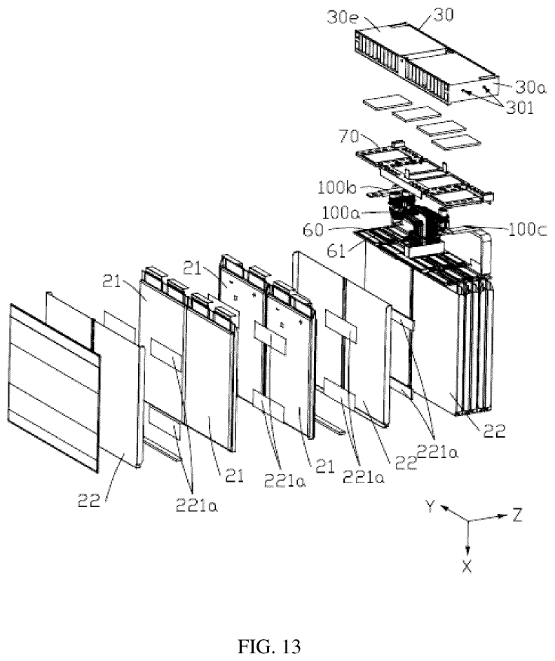

Referring to FIG. 1 to FIG. 7 and FIG. 13, an embodiment of the present application provides a battery module 100, including a housing 10, a cell assembly 20, and a heat sink 30. The housing 10 includes a first housing 11 and a second housing 12, where the first housing 11 is connected to the second housing 12. The first housing 11 forms a first space 101, and the cell assembly 20 is disposed in the first space 101. The heat sink 30 is disposed in the first space 101, and a second space 102 is formed between the heat sink 30, the first housing 11, and the second housing 12. The first housing 11 is provided with a first channel 11a and a first through hole 11b. The first space 101 is in communication with the second space 102 through the first channel 11a. The present application, by providing the first channel 11a and the first through hole 11b in the first housing 11, where the first channel 11a connects the first space 101 and the second space 102, allows liquid in the second space 102 to flow through the first channel 11a to the first space 101 and be discharged from the battery module 100 through the first through hole 11b, reducing the risk of short circuits caused by liquid inside the battery module 100 and improving the safety of the battery module.

In an embodiment, the battery module 100 further includes a first filling member 40. The first filling member 40 is detachably disposed in the first through hole 11b and is configured to unblock or seal the first through hole 11b. When the first filling member 40 is removed from the first through hole 11b, the first through hole 11b is unblocked and can be used for liquid drainage. When the first filling member 40 is disposed in the first through hole 11b, the first through hole 11b is sealed, reducing the entry of liquid into the first channel 11a through the first through hole 11b. Optionally, the first through hole 11b includes a threaded hole, and the first filling member 40 includes a screw. Optionally, a first gap 40a is provided between the first filling member 40 and the first through hole 11b. The first gap 40a allows gas and water in the first space 101 and the second space 102 to be discharged, balancing the air pressure in the first space 101 and the second space 102, and the first gap 40a can also restrict liquid from entering the first space 101 through the first through hole 11b.

Optionally, when it is necessary to further reduce the entry of liquid into the first channel 11a through the first through hole 11b, a sealing member (not shown) is provided in the first gap 40a.

In an embodiment, the first housing 11 includes a first wall 111, a second wall 112, a third wall 113, a fourth wall 114, and a bottom wall 115. The first wall 111 and the second wall 112 are disposed opposite to each other, and the first channel 11a is disposed in at least one of the first wall 111 and the second wall 112. The third wall 113 and the fourth wall 114 are disposed opposite to each other. The bottom wall 115 is disposed opposite to the second housing 12. The first wall 111 is connected to the third wall 113 and the fourth wall 114, the second wall 112 is connected to the third wall 113 and the fourth wall 114, and the bottom wall 115 is connected to the first wall 111, the second wall 112, the third wall 113, and the fourth wall 114, forming the first space 101. Optionally, the first channel 11a is disposed in the first wall 111. Optionally, the first channel 11a is disposed in the second wall 112. Optionally, the first channel 11a is disposed in both the first wall 111 and the second wall 112, improving liquid drainage efficiency. Optionally, the first channel 11a disposed in the first wall 111 and the second wall 112 can be configured as one or multiple, for example, two. Optionally, the first channel 11a can also be disposed in at least one of the third wall 113 and the fourth wall 114. Optionally, when the battery module 100 is in a positioned state, the bottom wall 115 faces a placement surface, serving as a load-bearing surface when the battery module 100 is positioned, and under gravity, liquid or gas can be discharged through the first gap 40a.

In an embodiment, the first through hole 11b is disposed in any one of the first wall 111, the second wall 112, the third wall 113, and the fourth wall 114.

In an embodiment, the first through hole 11b is disposed in the bottom wall 115, facilitating liquid drainage when the battery module is positioned or moving. The present application takes the example of the first through hole 11b being disposed in the bottom wall 115 for illustration.

Optionally, the first wall 111, the second wall 112, the third wall 113, the fourth wall 114, and the bottom wall 115 can be connected to form the first housing 11 through methods such as screw locking, welding, or bonding. Optionally, the first wall 111, the second wall 112, the third wall 113, the fourth wall 114, and the bottom wall 115 can also be integrally formed, for example, by providing an injection molding process to form an integrally molded structure, or by forming an integrally molded structure through an extrusion process using metal materials.

Optionally, the first housing 11 includes a thermally conductive material, improving heat dissipation performance. Optionally, the thermally conductive material includes metallic thermally conductive materials and thermally conductive insulating materials, where the insulating material can cover the outer surface of the metallic thermally conductive material. Optionally, the metallic thermally conductive material of the first housing 11 includes aluminum. Optionally, the surface of the first housing 11 includes a thermally conductive metallic material, facilitating improved heat dissipation.

To better illustrate the structure of the battery module 100, the structure of the battery module 100 will be described in conjunction with X, Y, Z coordinate axes, where the X, Y, Z coordinate axes are pairwise perpendicular. The X direction is defined as the first direction, the Y direction as the second direction, and the Z direction as the third direction, where the first direction X is the direction in which the second housing 12 and the bottom wall 115 are arranged, the second direction Y is the direction in which the third wall 113 and the fourth wall 114 are arranged, and the third direction Z is the direction in which the first wall 111 and the second wall 112 are arranged. The first direction X is perpendicular to both the second direction Y and the third direction Z.

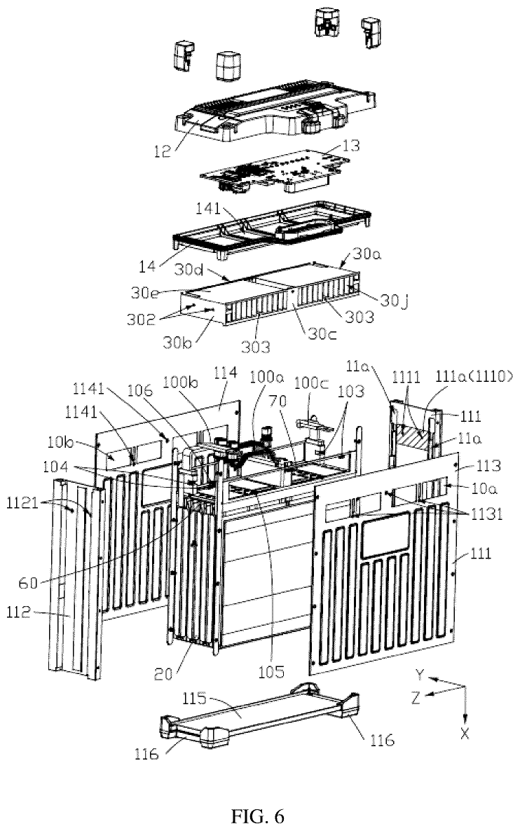

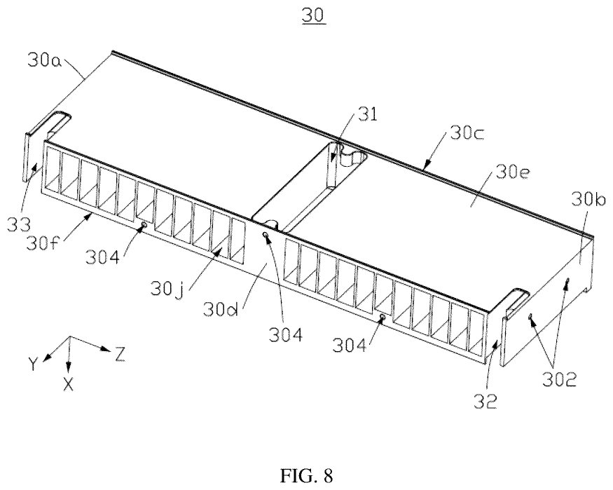

Referring to FIG. 6 and FIG. 8, in an embodiment, the heat sink 30 is sealingly connected to surfaces of the first wall 111, the second wall 112, the third wall 113, and the fourth wall 114. The heat sink 30 includes a first sidewall 30a and a second sidewall 30b disposed along the third direction Z. The first sidewall 30a is provided with a first connecting hole 301, and the second sidewall 30b is provided with a second connecting hole 302. The first wall 111 is provided with a third connecting hole 1111, and the second wall 112 is provided with a fourth connecting hole 1121. The battery module 100 includes a first fastener 103. The first fastener 103 passes through the third connecting hole 1111 and is disposed in the first connecting hole 301, fixing the first sidewall 30a to the first wall 111. The battery module 100 includes a second fastener 104. The second fastener 104 passes through the fourth connecting hole 1121 and is disposed in the second connecting hole 302, fixing the second sidewall 30b to the second wall 112. By fixing the first sidewall 30a of the heat sink 30 to the first wall 111 and the second sidewall 30b to the second wall 112, it facilitates the sealed separation of the first space 101 and the second space 102.

In an embodiment, the heat sink 30 includes a third sidewall 30c and a fourth sidewall 30d disposed along the second direction Y. The third sidewall 30c is provided with a fifth connecting hole 303, and the fourth sidewall 30d is provided with a sixth connecting hole 304. The third wall 113 is provided with a seventh connecting hole 1131, and the fourth wall 114 is provided with an eighth connecting hole 1141. The battery module 100 includes a third fastener 105. The third fastener 105 passes through the seventh connecting hole 1131 and is disposed in the fifth connecting hole 303, fixing the third sidewall 30c to the third wall 113. The battery module 100 includes a fourth fastener 106. The fourth fastener 106 passes through the eighth connecting hole 1141 and is disposed in the sixth connecting hole 304, fixing the fourth sidewall 30d to the fourth wall 114. By fixing the third sidewall 30c of the heat sink 30 to the third wall 113 and the fourth sidewall 30d to the fourth wall 114, it enhances the connection strength between the heat sink 30 and the first housing 11 and improves the sealing performance of the connection between the heat sink 30 and the first housing 11, facilitating the sealed separation of the first space 101 and the second space 102. Optionally, the first fastener 103, the second fastener 104, the third fastener 105, and the fourth fastener 106 include screws.

In an embodiment, the first wall 111 has a first wall region 111a. The first wall region 111a is provided with a first housing insulator 1110. The first housing insulator 1110 is disposed between the first wall region 111a and the first sidewall 30a. The first housing insulator 1110 closely fits the first wall region 111a and the first sidewall 30a, further increasing the sealing performance of the connection between the first sidewall 30a and the first wall 111, which further facilitates the sealed separation of the first space 101 and the second space 102. Optionally, the first housing insulator 1110 has thermal conductivity, transferring heat from the heat sink 30 to the first wall 111. Optionally, the first housing insulator 1110 includes glue. Optionally, the glue includes thermally conductive glue. Optionally, the first housing insulator 1110 can also prevent external impurities, such as water, from entering the cell assembly 20.

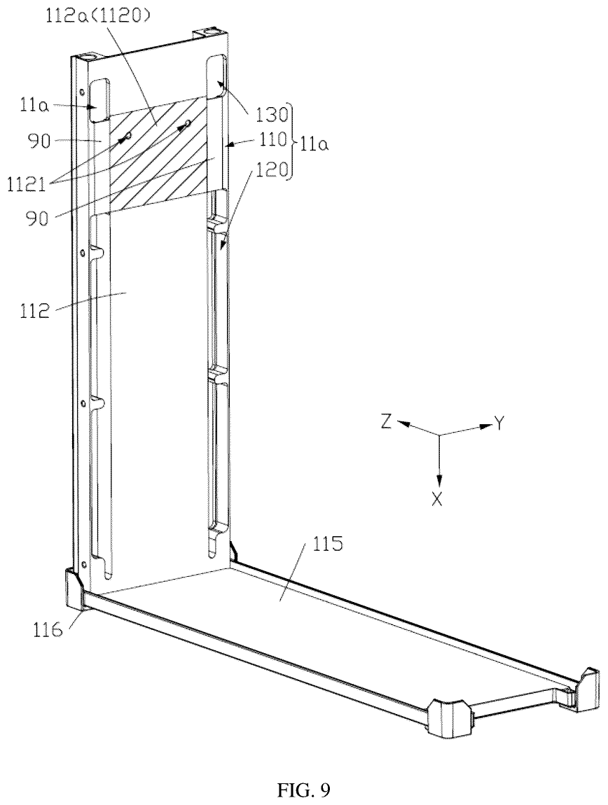

Referring to FIG. 6 and FIG. 9, in an embodiment, the second wall 112 has a second wall region 112a. The second wall region 112a is provided with a second housing insulator 1120. The second housing insulator 1120 is located between the second wall region 112a and the second sidewall 30b. The second housing insulator 1120 closely fits the second wall region 112a and the second sidewall 30b, further increasing the sealing performance of the connection between the second sidewall 30b and the second wall 112, which further facilitates the sealed separation of the first space 101 and the second space 102. Optionally, the second housing insulator 1120 has thermal conductivity, transferring heat from the heat sink 30 to the second wall 112. Optionally, the second housing insulator 1120 includes glue. Optionally, the glue includes thermally conductive glue. Optionally, the second housing insulator 1120 can also prevent external impurities, such as water, from entering the cell assembly 20.

In an embodiment, the third sidewall 30c is provided with a third housing insulator (not shown). The third housing insulator is disposed between the third sidewall 30c and the third wall 113, further increasing the sealing performance of the connection between the third sidewall 30c and the third wall 113, which further facilitates the sealed separation of the first space 101 and the second space 102. Optionally, the third housing insulator includes glue. Optionally, the glue includes thermally conductive glue. Optionally, the third housing insulator can also prevent external impurities, such as water, from entering the cell assembly 20.

The fourth sidewall 30d is provided with a fourth housing insulator (not shown). The fourth housing insulator is disposed between the fourth sidewall 30d and the fourth wall 114, further increasing the sealing performance of the connection between the fourth sidewall 30d and the fourth wall 114, which further facilitates the sealed separation of the first space 101 and the second space 102. Optionally, the fourth housing insulator includes glue. Optionally, the glue includes thermally conductive glue. Optionally, the fourth housing insulator can also prevent external impurities, such as water, from entering the cell assembly 20. The first housing insulator 1110, the second housing insulator 1120, the third housing insulator, and the fourth housing insulator, further facilitate the sealed connection between the heat sink 30 and the surfaces of the first wall 111, the second wall 112, the third wall 113, and the fourth wall 114, and further facilitate the sealed separation of the first space 101 and the second space 102.

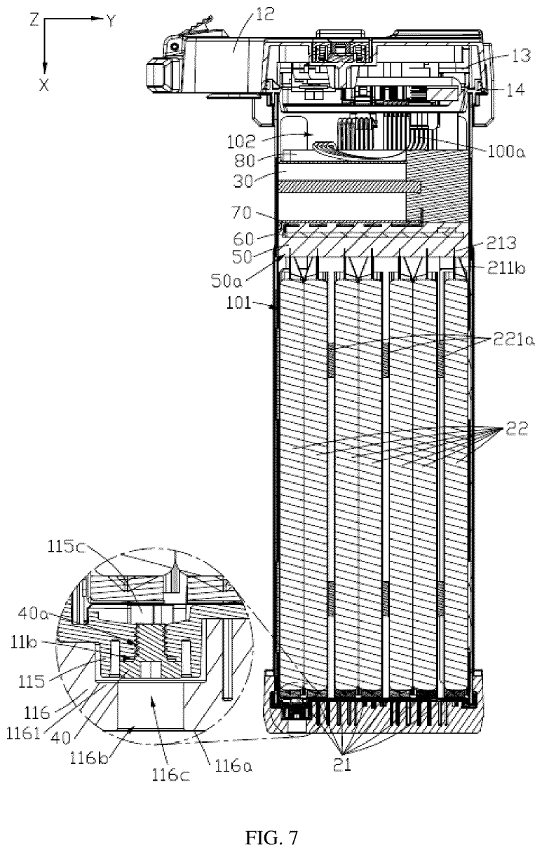

Referring to FIG. 7, in an embodiment, the battery module 100 further includes a first insulator 50. The first insulator 50 is disposed in a second gap 50a between the cell assembly 20 and the heat sink 30, sealing and insulating the space between the cell assembly 20 and the heat sink 30. The first insulator 50 is connected to inner surfaces of the first wall 111, the second wall 112, the third wall 113, and the fourth wall 114, further facilitating the sealed separation of the first space 101 and the second space 102. When the battery module 100 is subjected to external impact forces, the first insulator 50 can enhance the protection of the battery module 100. Optionally, the first insulator 50 has a good thermal conductivity coefficient, facilitating improved heat dissipation of the battery module 100.

In an embodiment, the first insulator 50 is configured to be formed by curing a curable first insulating material disposed in the battery module 100. Optionally, the first insulator 50 includes one of polyurethane glue, epoxy glue, or silicone glue. Optionally, the insulating material includes thermally conductive silicone glue.

In an embodiment, the first insulator 50 is formed by curing foamed glue.

In an embodiment, the cell assembly 20 and the heat sink 30 are installed in the first housing 11, and the heat sink 30 is connected to the first housing 11. Then, the first housing 11 is inverted along the first direction X, at which point the bottom wall 115 is not connected to the first wall 111, the second wall 112, the third wall 113, and the fourth wall 114. A flowable first insulating material is injected into the battery module 100, where the flowable first insulating material is injected into the battery module 100 from the bottom of the cell assembly 20 along a direction opposite to the first direction X. After the first insulator 50 is cured, the bottom wall 115 is installed on the first wall 111, the second wall 112, the third wall 113, and the fourth wall 114.

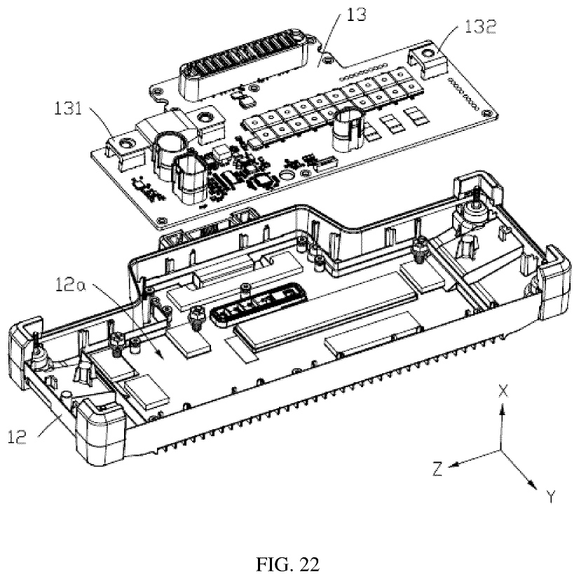

Referring to FIG. 6 and FIG. 22, in an embodiment, the battery module 100 further includes a second circuit board 13. The second housing 12 has a second housing recess 12a, and the second circuit board 13 is disposed in the second housing recess 12a and is insulated from the second housing 12. The second circuit board 13 is provided with a first connection portion 131 and a second connection portion 132, where the first connection portion 131 and the second connection portion 132 are electrically connected to other conductive components.

Optionally, the second circuit board 13 includes a BMS (Battery Management System) component. The BMS component includes multiple electronic components, which can implement functions such as control, protection, communication, battery capacity calculation, signal transmission, and electrical energy transmission for the cell 21. Optionally, the second circuit board 13 includes a flexible printed circuit (FPC, Flexible Printed Circuit). Optionally, the second circuit board 13 includes a printed circuit board (PCB, Flexible Printed Circuit), and the second circuit board 13 is provided with multiple conductive traces (not shown).

In an embodiment, the battery module 100 further includes a connecting bracket 14. The connecting bracket 14 is disposed between the first housing 11 and the second housing 12, and the first housing 11 and the second housing 12 are connected to the connecting bracket 14. The connecting bracket 14 is disposed between the second circuit board 13 and the heat sink 30, reducing the risk of a short circuit between the second circuit board 13 and the heat sink 30. Optionally, the connecting bracket 14 is made of an insulating material.

In an embodiment, a second space 102 is formed between the second circuit board 13 and the heat sink 30. The connecting bracket 14 is provided with a bracket through hole 141, where the bracket through hole 141 is in communication with the second space 102, facilitating heat dissipation from the heat sink 30 to the second circuit board 13.

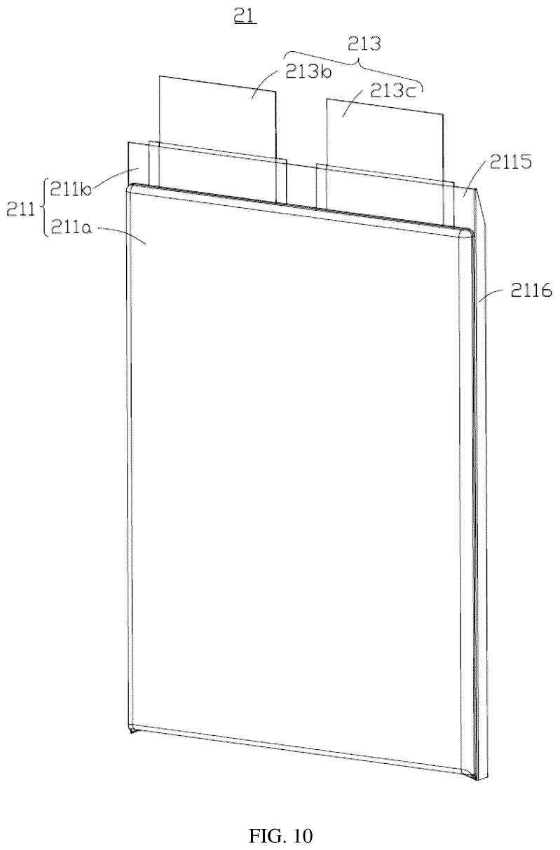

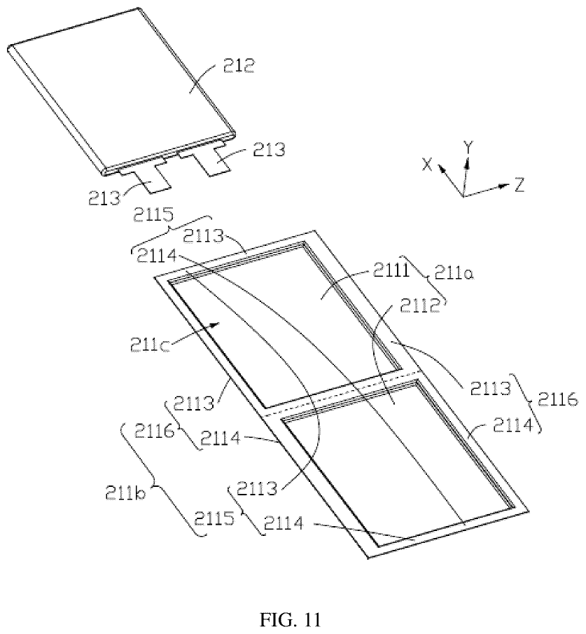

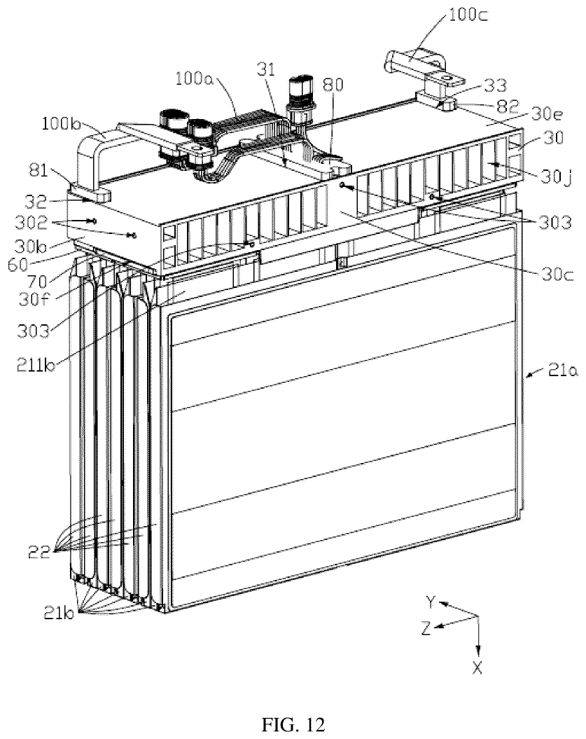

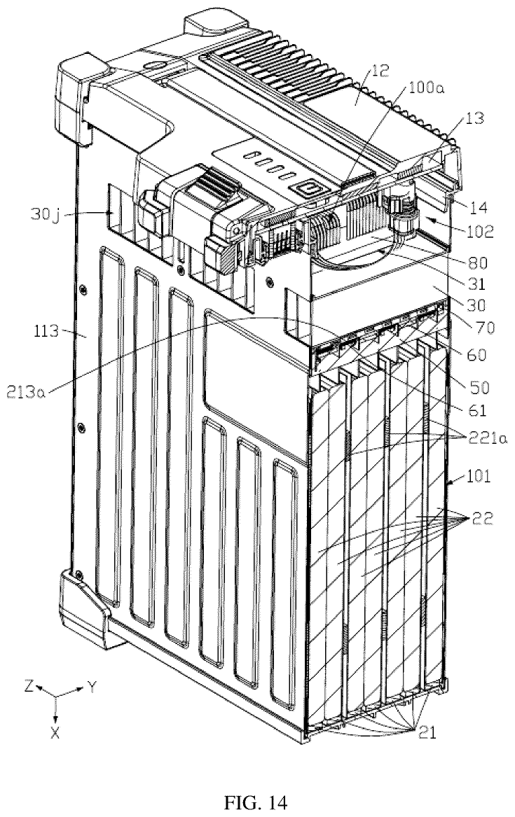

Referring to FIG. 10 to FIG. 14, in an embodiment, the cell assembly 20 includes a cell 21. The cell 21 includes a cell housing 211, an electrode assembly 212 disposed in the cell housing 211, and an electrode terminal 213 connected to the electrode assembly 212 and extending from the cell housing 211. The electrode terminal 213 passes through a first circuit board 60 and is connected to a side of the first circuit board 60, the side of the first circuit board 60 being a side facing away from the cell housing 211. The cell housing 211 includes a first portion 211a and a second portion 211b. The first portion 211a accommodates the electrode assembly 212, the second portion 211b is connected to the first portion 211a, and the electrode terminal 213 extends from the second portion 211b.

In an embodiment, the cell assembly 20 includes a plurality of cells 21, where the plurality of cells 21 are stacked along the second direction Y.

In an embodiment, the cell assembly 20 includes a plurality of cells 21 stacked along the second direction Y. Optionally, the cell assembly 20 includes a plurality of cells 21, where a part of the cells 21 are stacked along the second direction Y to form a first row of cells 21a, and a part of the cells 21 are stacked along the second direction Y to form a second row of cells 21b. The first row of cells 21a and the second row of cells 21b are arranged along the third direction Z.

In an embodiment, the cell 21 is in contact with and connected to the first housing 11, dissipating heat from the cell 21 to the external environment through the first housing 11.

In an embodiment, the cell housing 211 includes a first shell 2111 and a second shell 2112, where the first shell 2111 is connected to the second shell 2112. At least one of the first shell 2111 and the second shell 2112 is provided with a first recess 211c, and the electrode assembly 212 is disposed in the first recess 211c. The first shell 2111 and the second shell 2112 can be folded along a connection position, causing the first shell 2111 and the second shell 2112 to overlap, forming the first portion 211a to enclose the electrode assembly 212. Peripheral sides of the first shell 2111 extend outward to form a plurality of first extension portions 2113, and peripheral sides of the second shell 2112 extend outward to form a plurality of second extension portions 2114. After the first shell 2111 and the second shell 2112 are folded along the connection position, the first extension portions 2113 and the second extension portions 2114 overlap and are sealingly connected, forming the second portion 211b. Optionally, the first extension portions 2113 and the second extension portions 2114 are sealingly connected by a sealant. The second portion 211b includes a first sealing portion 2115 and a second sealing portion 2116. The first sealing portion 2115 is disposed opposite to the connection position, and the electrode terminal 213 extends from the first sealing portion 2115 out of the first portion 211a. Optionally, the second portion 211b includes two second sealing portions 2116, where the two second sealing portions 2116 are disposed opposite to each other along the third direction Z. Optionally, the second portion 211b includes one first sealing portion 2115, and the cell 21 includes two electrode terminals 213, where the two electrode terminals 213 extend from the first sealing portion 2115 out of the cell housing 211. In other embodiments, the first shell 2111 and the second shell 2112 are spaced apart, and the second portion 211b includes two first sealing portions 2115. The two first sealing portions 2115 are disposed opposite to each other along the first direction X. The cell 21 includes two electrode terminals 213, where one electrode terminal 213 extends from one of the first sealing portions 2115 out of the cell housing 211, and another electrode terminal 213 extends from another of the first sealing portions 2115 out of the cell housing 211. The two electrode terminals 213 are disposed opposite to each other along the first direction X.

In an embodiment, the first insulator 50 is disposed between the heat sink 30 and the cell housing 211. The first insulator 50 covers a part of the electrode terminal 213 extending from the cell housing 211, enhancing the fixation of the electrode terminal 213 and improving heat dissipation for the electrode terminal 213.

In an embodiment, the first insulator 50 covers a part of the electrode terminal 213 extending from the cell housing 211 and at least a part of the first sealing portion 2115, enhancing the protection of the first sealing portion 2115 and improving heat dissipation for the cell housing 211.

In an embodiment, the electrode assembly 212 includes a wound structure formed by winding a positive electrode sheet, a negative electrode sheet, and a separator. In other embodiments, the electrode assembly 212 can also be a laminated structure, where a positive electrode sheet, a separator, and a negative electrode sheet are sequentially stacked to form an electrode assembly 212 unit, and a plurality of electrode assembly 212 units are stacked to form the electrode assembly 212. Optionally, the cell housing 211 includes an aluminum-plastic film. Optionally, the cell 21 includes a pouch cell.

In an embodiment, the battery module 100 further includes a first circuit board 60. The first circuit board 60 is provided with a plurality of first conductive sheets 61. Optionally, the first conductive sheet 61 can be a copper foil disposed on the first circuit board 60, where the copper foil is connected to the wiring of the first circuit board 60. Optionally, the first conductive sheet 61 can be a conductive sheet disposed on the first circuit board 60, such as a copper busbar, where the conductive sheet is welded to the first circuit board 60.

Optionally, the first circuit board 60 includes a flexible printed circuit (FPC, Flexible Printed Circuit). Optionally, the first circuit board 60 includes a printed circuit board (PCB, Printed Circuit Board). The first circuit board 60 can collect information such as current, voltage, resistance, and temperature of the cell assembly 20.

In an embodiment, the electrode terminal 213 is provided with a welding portion 213a extending from the cell housing 211, where the welding portion 213a is formed by bending the electrode terminal 213. Electrode terminals 213 of adjacent cells 21 pass through the first circuit board 60 and are bent toward each other, connecting to the first conductive sheet 61. In an embodiment, the electrode terminal 213 includes a first terminal 213b and a second terminal 213c, where the first terminal 213b and the second terminal 213c have opposite polarities, one of the first terminal 213b and the second terminal 213c being a positive terminal and the other being a negative terminal. Along the first direction X, a projection of the welding portion 213a of the first terminal 213b of a cell 21 at least partially overlaps with a projection of the welding portion 213a of the second terminal 213c of an adjacent cell 21. The first terminal 213b and the second terminal 213c of adjacent cells 21 are bent toward each other, and the welding portion 213a of the first terminal 213b and the welding portion 213a of the second terminal 213c are stacked and connected. By connecting the welding portions 213a of adjacent cells 21 to each other and connecting the welding portions 213a to the first circuit board 60, the processing steps are reduced.

In an embodiment, the first circuit board 60 is provided with a welding region, and the welding portion 213a is welded to the welding region. Optionally, the welding region can be a copper foil on the first circuit board 60.

In other embodiments, along the first direction X, a projection of the first terminal 213b of a cell 21 can also at least partially overlap with a projection of the first terminal 213b of an adjacent cell 21 and be connected through the first circuit board 60, achieving parallel connection between cells 21.

In an embodiment, the cell assembly 20 further includes a plurality of heat dissipating portions 22. The heat dissipating portions 22 are in contact with and connected to the cells 21, dissipating heat from the cells 21. Optionally, the heat dissipating portions 22 are in contact with and connected to the first housing 11, transferring heat from the cells 21 to the first housing 11, thereby dissipating heat from the cells 21 through the first housing 11. Optionally, the heat dissipating portions 22 include aluminum shells.

In an embodiment, along the third direction Z, a projection of the heat dissipating portion 22 overlaps with a projection of the cell housing 211. Along the second direction Y, a projection of the heat dissipating portion 22 overlaps with a projection of the cell housing 211. Along the first direction X, a projection of the heat dissipating portion 22 overlaps with a projection of the cell housing 211, increasing the contact area between the heat dissipating portion 22 and the cell housing 211, improving heat dissipation efficiency.

In an embodiment, a first elastic member 221a is provided between adjacent heat dissipating portions 22, providing expansion space for the cells 21. Optionally, the first elastic member 221a includes foam.

In an embodiment, the battery module 100 further includes an insulating bracket 70. The insulating bracket 70 covers a part of the first circuit board 60, insulating the first circuit board 60. A first insulator 50 is provided between the insulating bracket 70 and the first circuit board 60, and the insulating bracket 70 and the first circuit board 60 are connected through the first insulator 50, where the first insulator 50 can further insulate the first circuit board 60.

Optionally, the insulating bracket 70 is made of an insulating material. Optionally, the insulating bracket 70 is made of a metal material and an insulating material, where the insulating material can cover the outer surface of the metal material.

In an embodiment, the battery module further includes a sampling wire harness 100a. The sampling wire harness 100a is connected to the first circuit board 60, passes through the insulating bracket 70 and the heat sink 30, and is connected to the second circuit board 13.

In an embodiment, the battery module 100 further includes a first electrical connection portion 100b and a second electrical connection portion 100c. The first electrical connection portion 100b and the second electrical connection portion 100c are used for the input or output of electrical energy. Optionally, the first electrical connection portion 100b and the second electrical connection portion 100c are welded to the first circuit board 60. Optionally, the first electrical connection portion 100b is connected to one of the first terminal 213b and the second terminal 213c, and the second electrical connection portion 100c is connected to the other. Optionally, the first electrical connection portion 100b and the second electrical connection portion 100c include copper busbars.

In an embodiment, the heat sink 30 includes a first surface 30e and a second surface 30f disposed along the first direction X. The second space 102 is formed between the first surface 30e and the second circuit board 13, and the second surface 30f is connected to the first insulator 50. A first insulator 50 is provided between the second surface 30f and the insulating bracket 70, and the second surface 30f and the insulating bracket 70 are connected through the first insulator 50.

In an embodiment, the heat sink 30 includes a first accommodation space 31. The first accommodation space 31 penetrates the heat sink 30 along the first direction X. Optionally, along the third direction Z, the first accommodation space 31 is located at a middle position of the heat sink 30. The sampling wire harness 100a passes through the first accommodation space 31 and is connected to the second circuit board 13.

In an embodiment, the heat sink 30 includes a second accommodation space 32. The second accommodation space 32 penetrates the heat sink 30 along the first direction X. The first electrical connection portion 100b passes through the insulating bracket 70 and the second accommodation space 32 and is connected to the first connection portion 131.

In an embodiment, the heat sink 30 includes a third accommodation space 33. The third accommodation space 33 penetrates the heat sink 30 along the first direction X. The second electrical connection portion 100c passes through the insulating bracket 70 and the third accommodation space 33 and is connected to the second connection portion 132.

In an embodiment, the battery module 100 further includes a second insulator 80. The second insulator 80 is disposed in the first accommodation space 31, and the second insulator 80 protrudes beyond the first surface 30e. By disposing the second insulator 80 in the first accommodation space 31 and having the second insulator 80 protrude beyond the first surface 30e of the heat sink 30, it reduces the possibility of liquid entering the first accommodation space 31, minimizes liquid accumulation in the first accommodation space 31, and facilitates the discharge of liquid from the battery module 100.

In an embodiment, the second insulator 80 is configured to be formed by curing a curable second insulating material disposed in the first accommodation space 31. Optionally, the second insulator 80 includes one of polyurethane glue, epoxy glue, or silicone glue. Optionally, the second insulator 80 includes foamed glue.

In an embodiment, the battery module 100 further includes a third insulator 81. The third insulator 81 is disposed in the second accommodation space 32, insulating and fixing the first electrical connection portion 100b. The third insulator 81 protrudes beyond the first surface 30e, reducing the possibility of liquid entering the second accommodation space 32, minimizing liquid accumulation in the second accommodation space 32, and facilitating the discharge of liquid from the battery module 100.

In an embodiment, the third insulator 81 is configured to be formed by curing a curable third insulating material disposed in the second accommodation space 32. Optionally, the third insulator 81 includes one of polyurethane glue, epoxy glue, or silicone glue. Optionally, the third insulator 81 includes foamed glue.

In an embodiment, the battery module 100 further includes a fourth insulator 82. The fourth insulator 82 is disposed in the third accommodation space 33, insulating and fixing the second electrical connection portion 100c. The fourth insulator 82 protrudes beyond the first surface 30e, reducing the possibility of liquid entering the third accommodation space 33, minimizing liquid accumulation in the third accommodation space 33, and facilitating the discharge of liquid from the battery module 100.

In an embodiment, the fourth insulator 82 is configured to be formed by curing a curable fourth insulating material disposed in the third accommodation space 33. Optionally, the fourth insulator 82 includes one of polyurethane glue, epoxy glue, or silicone glue. Optionally, the fourth insulator 82 includes foamed glue.

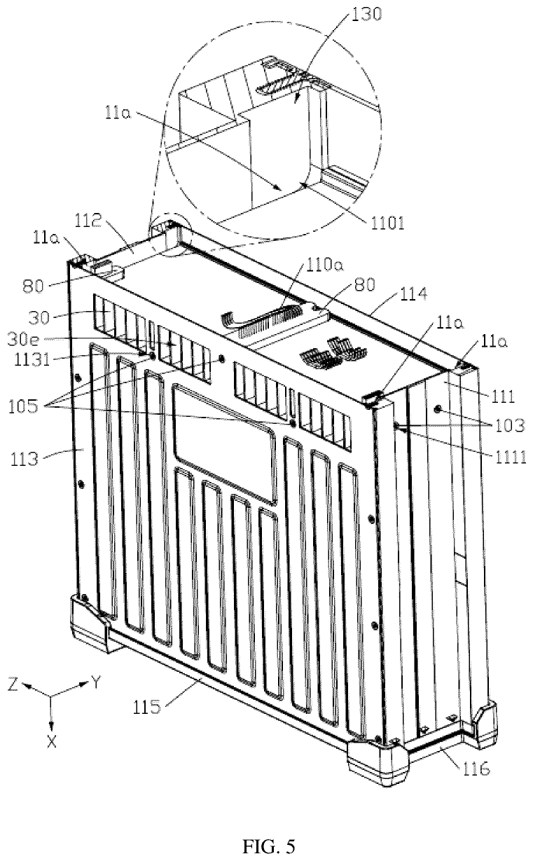

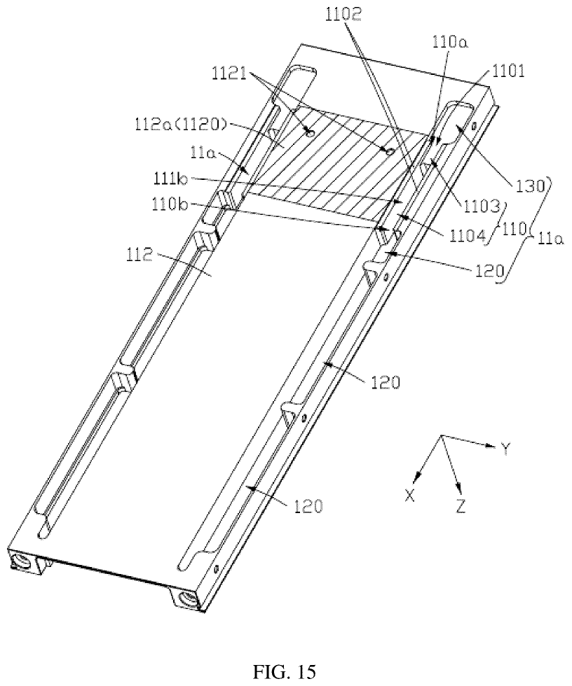

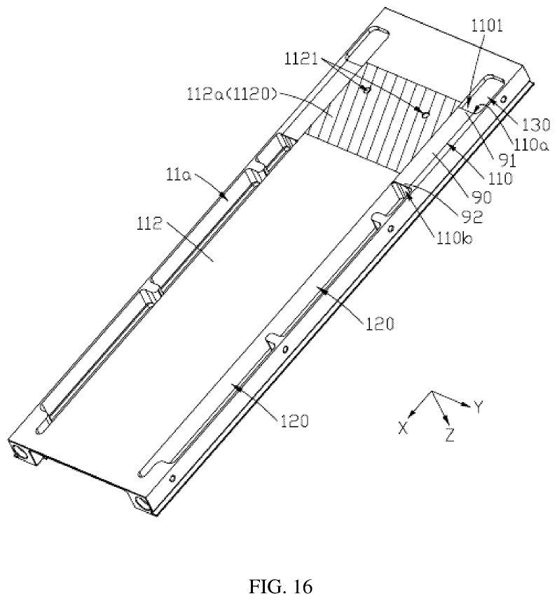

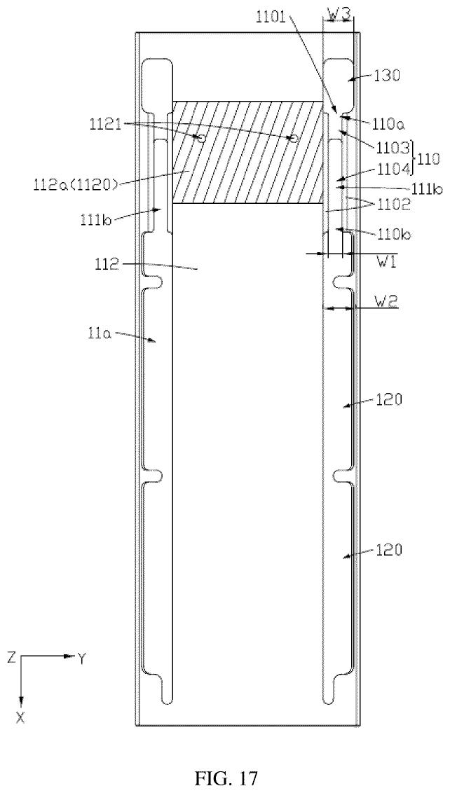

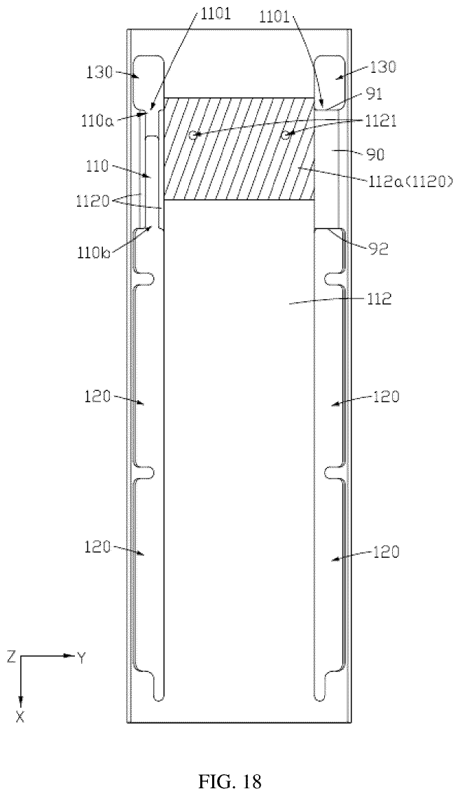

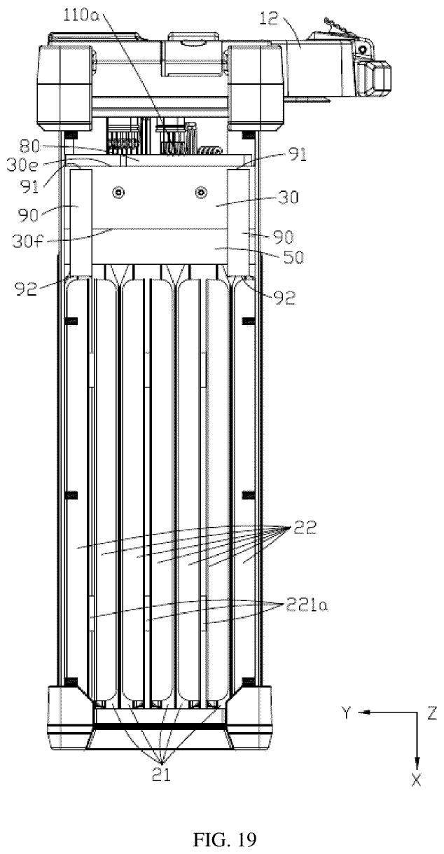

Referring to FIG. 5, and FIG. 15 to FIG. 19, in the present application, both the first wall 111 and the second wall 112 are provided with a first channel 11a. The following description will take the first channel 11a disposed in the second wall 112 as an example.

In an embodiment, the first channel 11a includes a first opening 1101 facing the second housing 12. The first opening 1101 serves as a liquid inlet, and liquid in the second space 102 enters the first channel 11a through the first opening 1101 and is discharged through the first through hole 11b. Optionally, along a direction opposite to the first direction X, the position of the first opening 1101 does not exceed the first surface 30e, facilitating the entry of liquid in the second space 102 into the first channel 11a and aiding liquid drainage. Optionally, along a direction opposite to the first direction X, the position of the first opening 1101 is lower than the first surface 30e, further facilitating liquid drainage.

In an embodiment, the first channel 11a extends along the first direction X in the second wall 112. The first channel 11a includes a first segment 110 and a second segment 120 disposed along the first direction X, where the first segment 110 and the second segment 120 are in communication. The first segment 110 includes a first end 110a and a second end 110b disposed along the first direction X. The first end 110a is disposed at an end of the first segment 110, the end of the first segment 110 being an end facing away from the second segment 120, and the second end 110b is connected to the second segment 120. Along the third direction Z, a projection of the first segment 110 overlaps with a projection of the heat sink 30, a projection of the first segment 110 overlaps with a projection of the first insulator 50, and a projection of the first segment 110 overlaps with a projection of the cell housing 211. Along the third direction Z, a projection of the second segment 120 is spaced apart from a projection of the first insulator 50, and a projection of the second segment 120 overlaps with a projection of the cell housing 211. Along the first direction X, the second end 110b protrudes beyond the first insulator 50.

In an embodiment, along the third direction Z, the first channel 11a includes a second opening 111b facing the heat sink 30. The battery module 100 further includes a first separator 90. The first separator 90 covers at least a part of the second opening 111b. The first separator 90 includes a first side 91 and a second side 92 disposed along the first direction X. Along the first direction X, the first side 91 is not lower than the second surface 30f, and the second side 92 protrudes beyond the first insulator 50, reducing the entry of the first insulating material into the first channel 11a.

Optionally, along the first direction X, the first side 91 is disposed at the first end 110a. The position of the first side 91 is lower than the first surface 30e and higher than the second surface 30f, and the second side 92 protrudes beyond the first insulator 50, reducing the entry of flowable a first insulating material into the first segment 110 during inverted filling of the first insulating material, thereby lowering the risk of the first segment 110 being blocked and preventing liquid drainage.

In an embodiment, along the second direction Y, the first housing 11 is provided with two opposing step surfaces 1102. The first separator 90 is connected to the two step surfaces 1102 and covers at least a part of the first segment 110, facilitating the connection of the first separator 90 to the first housing 11.

In an embodiment, optionally, the second wall 112 is provided with two opposing step surfaces 1102. Along the third direction Z, a height of the step surfaces 1102 is lower than that of the second wall region 112a. The first separator 90 is disposed on the step surfaces 1102 and covers the first segment 110. Along the second direction Y, a projection of the first segment 110 is spaced apart from a projection of the heat sink 30, and a projection of the first segment 110 is spaced apart from a projection of the first insulator 50. Optionally, along the third direction Z, a surface of the first separator 90 is flush with a surface of the second wall region 112a, the surface of the first separator 90 being a surface facing away from the step surfaces 1102. A surface of the first separator 90 is connected to the second sidewall 30b of the heat sink 30, the surface of the first separator 90 being a surface facing away from the step surfaces 1102, increasing the sealing performance between the first separator 90 and the second sidewall 30b. Optionally, along the third direction Z, a surface of the first separator 90 protrudes beyond a surface of the second wall region 112a, the surface of the first separator 90 being a surface facing away from the step surfaces 1102. The surface of the first separator 90 facing away from the step surfaces 1102 is connected to the second sidewall 30b of the heat sink 30, allowing the first separator 90 and the second sidewall 30b, as well as the first separator 90 and the step surfaces 1102, to be compressively connected, further increasing the sealing performance between the first separator 90 and the second sidewall 30b.

In an embodiment, one side of the first separator 90 is connected to the step surfaces 1102, and another side is connected to the heat sink 30. Optionally, one side of the first separator 90 disposed along the third direction Z is bonded to the step surfaces 1102, and another side is bonded to the second sidewall 30b of the heat sink 30, further increasing the sealing performance between the first separator 90 and the second sidewall 30b. Optionally, the first separator 90 includes foam. Optionally, the first separator 90 is integrally formed with the second wall 112.

In an embodiment, the first channel 11a includes a third segment 130. The third segment 130 and the first segment 110 are disposed along the first direction X, and the third segment 130 is connected to the first segment 110. The third segment 130 and the first segment 110 are in communication through the first opening 1101. Along the third direction Z, a projection of the third segment 130 overlaps with a projection of the second accommodation space 32, and a projection of the third segment 130 overlaps with a projection of the second insulator 80. A part of the second insulator 80 is disposed in the third segment 130, and the second insulator 80 is spaced apart from the first opening 1101. The third segment 130 can accommodate a part of the second insulating material overflowing from the second accommodation space 32, reducing the risk of the second insulator 80 blocking the first segment 110 and preventing liquid drainage. Optionally, along the second direction Y, a width W1 of the first segment 110 is smaller than a width W3 of the third segment 130. By increasing the width of the third segment 130, more of the second insulator 80 can be accommodated, and by reducing the width of the first segment 110, the risk of the second insulator 80 blocking the first segment 110 and preventing liquid drainage can be further reduced. Optionally, along the second direction Y, a width W2 of the second segment 120 is greater than the width W1 of the first segment 110. By increasing the width of the second segment 120, liquid outflow is facilitated, improving liquid drainage efficiency and reducing the weight of the second wall 112, thereby lightening the battery module 100.

In an embodiment, the first segment 110 includes a first region 1103 and a second region 1104 in communication. The first opening 1101 is disposed in the first region 1103, the first region 1103 is in communication with the third segment 130, and the second region 1104 is in communication with the second segment 120. Along the third direction Z, a distance between the first region 1103 and the first separator 90 is smaller than a distance between the second region 1104 and the first separator 90, further reducing the entry of the second insulating material into the first segment 110 from the first opening 1101, thereby further lowering the risk of the second insulator 80 blocking the first segment 110 and preventing liquid drainage.

In an embodiment, the second wall 112 is provided with two first channels 11a, where the two first channels 11a are disposed along the second direction Y.

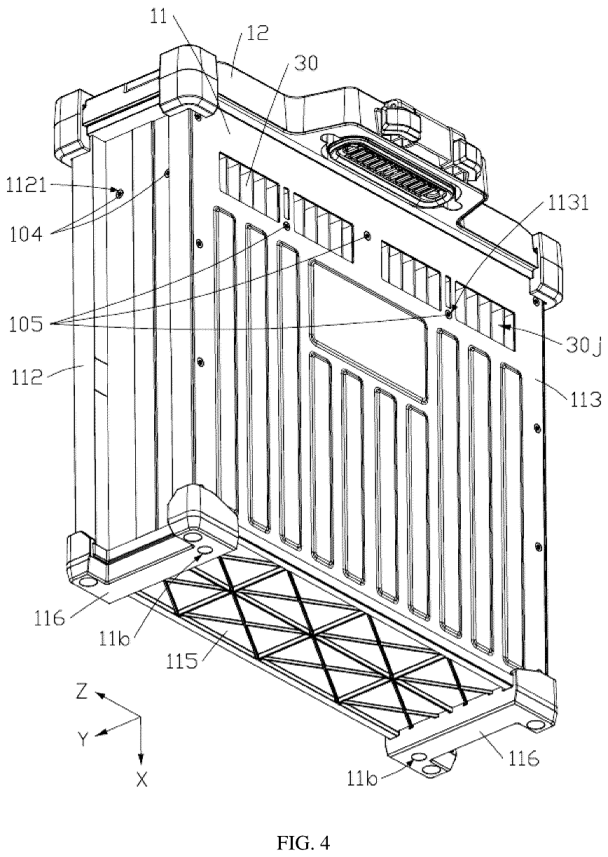

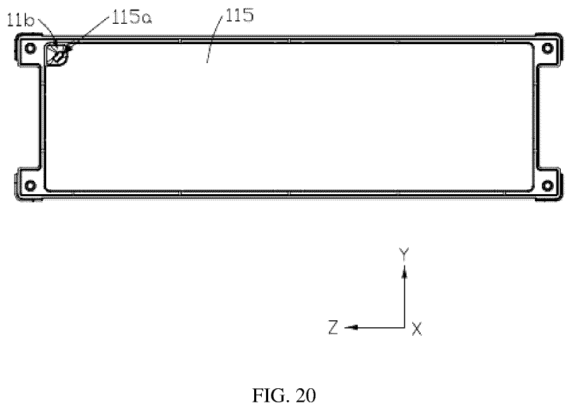

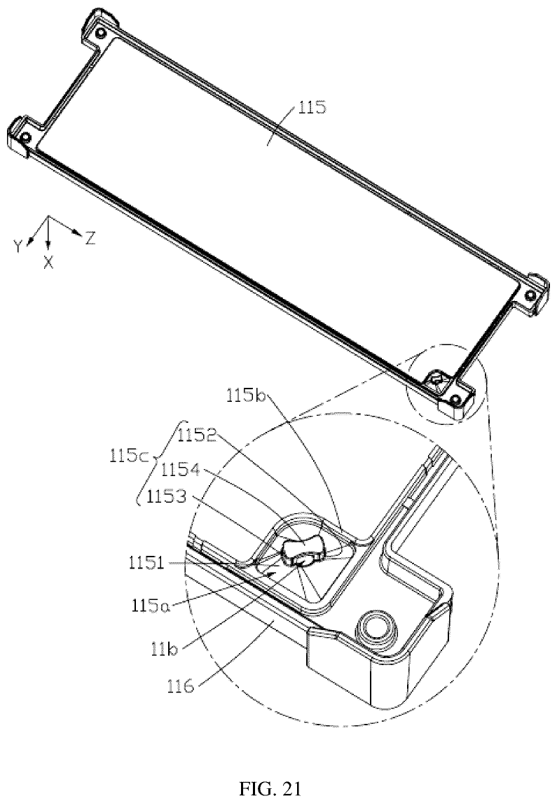

Referring to FIG. 4, FIG. 7, FIG. 20, and FIG. 21, in an embodiment, the bottom wall 115 includes a third region 115a. The third region 115a is connected to an edge of the first through hole 11b, and an end of the second segment 120 is in communication with the third region 115a, the end of the second segment 120 being an end facing away from the first segment 110. The third region 115a includes a plurality of inclined surfaces 1151. The plurality of inclined surfaces 1151 are sequentially connected in a clockwise or counterclockwise direction and converge toward the first through hole 11b, allowing liquid to collect toward the first through hole 11b, facilitating improved liquid drainage efficiency.

In an embodiment, the bottom wall 115 includes a fourth region 115b. The fourth region 115b is disposed at an edge of the third region 115a. The fourth region 115b protrudes from a surface of the bottom wall 115 along a direction opposite to the first direction X, reducing the overflow of liquid from the third region 115a to other regions of the bottom wall 115.

In an embodiment, the bottom wall 115 includes a first limiting member 115c. The first limiting member 115c is disposed in the third region 115a and is located above the first through hole 11b along the direction opposite to the first direction X. The first limiting member 115c can restrict a height to which the first filling member 40 protrudes from the bottom wall 115, reducing the risk of the first filling member 40 pressing against the cell 21, causing damage to the cell 21 and leading to a short circuit. Optionally, the first limiting member 115c includes a first limiting portion 1152, a second limiting portion 1153, and a third limiting portion 1154. The first limiting portion 1152 and the second limiting portion 1153 are disposed opposite to each other and are connected to an edge of the first through hole 11b. The third limiting portion 1154 is connected to the first limiting portion 1152 and the second limiting portion 1153 and is located above the first through hole 11b along the direction opposite to first direction X. When the first filling member 40 is disposed in the first through hole 11b, a part of the first filling member 40 protruding from the first through hole 11b contacts the third limiting portion 1154.

In an embodiment, the first housing 11 further includes a first connecting member 116. The first connecting member 116 includes a support portion 1161, and the bottom wall 115 is connected to the support portion 1161. The bottom wall 115 and the first connecting member 116 are disposed along the first direction X. The first connecting member 116 includes a bottom surface 116a, and when the battery module 100 is positioned, the bottom surface 116a is connected to a placement surface. The first connecting member 116 is provided with a second through hole 116b. The second through hole 116b penetrates the bottom surface 116a along the first direction X. The first filling member 40 is disposed in the second through hole 116b and is connected to the first through hole 11b. Along the first direction X, a third space 116c is provided between the first filling member 40 and the bottom surface 116a. The third space 116c allows the first filling member 40 to be distanced from the placement surface, preventing direct contact between the first filling member 40 and liquid on the placement surface, reducing liquid erosion of the first filling member 40 and minimizing the entry of liquid into the battery module 100 through the first through hole 11b.

Optionally, the first filling member 40 is disposed in the second through hole 116b along a direction opposite to the first direction X and is connected to the first through hole 11b, reducing the accumulation of liquid on the surface of the first filling member 40, further reducing liquid erosion of the first filling member 40 and minimizing the entry of liquid into the battery module 100 through the first through hole 11b.

Optionally, two first connecting members 116 are provided, where the two first connecting members 116 are disposed along the third direction Z and are connected to both sides of the bottom wall 115 along the third direction Z.

Referring to FIG. 6 and FIG. 8, in an embodiment, the first housing is provided with a first opening 10a and a second opening 10b, where the first opening 10a and the second opening 10b are in communication with the exterior. The heat sink 30 is provided with a second channel 30j, where the second channel 30j connects the first opening 10a and the second opening 10b. The heat sink 30 dissipates heat from the electrode terminal 213 through the second channel 30j from the first opening 10a and the second opening 10b to the external environment, improving heat dissipation for the electrode terminal 213 and reducing the temperature of the battery module 100. Optionally, the heat sink 30 can dissipate heat from the first circuit board 60, further improving heat dissipation for the battery module 100. Optionally, the first opening 10a is disposed on the third wall 113, and the second opening 10b is disposed on the fourth wall 114. Along the second direction Y, the first opening 10a penetrates the third wall 113, and the second opening 10b penetrates the fourth wall 114.

In an embodiment, the battery module 100 can utilize external air, where the flow of air carries away heat from the first circuit board 60 and the cell assembly 20. In an embodiment, the battery module 100 may be applied to a device that is in a static state during use, and when the battery module 100 is in a static state, heat dissipation can be implemented through natural air flow or an external air cooling device. In an embodiment, the battery module 100 may be applied to a device that is in a dynamic state during use, for example, a drone or an electric motor bicycle. Because air flow velocity is quicker during movement of the device, quick heat dissipation for the battery module 100 can be implemented.

In an embodiment, the heat sink 30 has a plurality of second channels 30j, where the plurality of second channels 30j are arranged along the third direction Z. Optionally, one of the outermost two second channels 30j disposed along the third direction Z is in communication with the first accommodation space 31, and the other of the outermost two second channels 30j disposed along the third direction Z is in communication with the second accommodation space 32.

In an embodiment, an outer surface of the heat sink 30 includes a metal material layer, facilitating heat dissipation, such as aluminum. Optionally, the material of the heat sink 30 includes a metal material, and the outer surface of the heat sink 30 can be coated with an insulating layer. Optionally, the material of the heat sink 30 includes a metal material, and the outer surface of the heat sink 30 includes a metal material layer.

In an embodiment, when performing inverted filling of the first insulating material, the cell 21, the first circuit board 60, the insulating bracket 70, and the heat sink 30 are first installed in the first housing 11, and the heat sink 30 is connected to the first housing 11. Then, a second insulating material is injected into the first accommodation space 31, a third insulating material is injected into the second accommodation space 32, and a fourth insulating material is injected into the third accommodation space 33. After the second insulating material, the third insulating material, and the fourth insulating material are cured, sealing the heat sink 30, the first housing 11 is inverted, and a flowable first insulating material is injected into the battery module 100 from the bottom of the cell assembly 20 along a direction opposite to the first direction X. The first separator 90 blocks the insulating material, minimizing the first insulating material entering the first channel 11a. After the first insulating material is cured, it forms the first insulator 50.

In an embodiment, the same insulating material is injected into the first accommodation space 31, the second accommodation space 32, and the third accommodation space 33.

In an embodiment, different insulating materials are used for the second insulator 80 injected into the first accommodation space 31, the second accommodation space 32, and the third accommodation space 33.

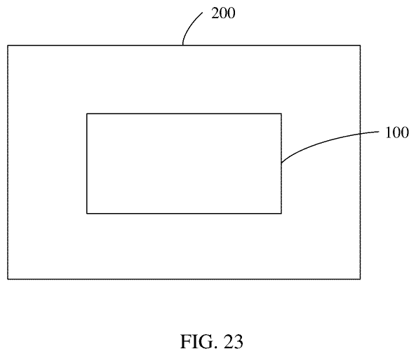

Referring to FIG. 23, the present application further provides an electric device 200 using the foregoing battery module 100. In an embodiment, the electric device 200 in the present application may be, but is not limited to, a drone, a backup power source, an electric automobile, an electric motorcycle, an electric motor bicycle, an electric tool, or a large household battery.

Those of ordinary skill in the art should be aware that some foregoing embodiments are only intended to describe the present application, but not to limit the present application. Appropriate modifications and variations made to some foregoing embodiments without departing from the essential spirit and scope of the present application all fall within the scope of the present application.

What is claimed is:

1. A battery module comprising:
a housing comprising a first housing and a second housing, the first housing is connected to the second housing, the first housing forms a first space; the first housing comprises a first wall, a second wall, and a bottom wall, the first wall and the second wall are connected to the bottom wall;
a cell assembly accommodated in the first space; and
a heat sink disposed in the first space; the heat sink, the first housing, and the second housing form a second space; and along a first direction, the cell assembly is located between the heat sink and the bottom wall;
wherein at least one of the first wall or the second wall is provided with a first channel, and the first space is in communication with the second space through the first channel; and
the first housing is provided with a first through hole in communication with the first space and an exterior of the first housing.

2. The battery module according to claim 1, further comprising a first filling member, the first filling member is detachably disposed in the first through hole.

3. The battery module according to claim 2, wherein the first filling member is connected to the first housing, and a first gap is provided in the first through hole, the first gap is devoid of the first filling member.

4. The battery module according to claim 1, wherein the first through hole is disposed in the bottom wall.

5. The battery module according to claim 1, wherein the first housing comprises a third wall and a fourth wall disposed opposite to each other along a second direction, the first wall and the second wall are disposed opposite to each other along a third direction, the first wall is connected to the third wall and the fourth wall, the second wall is connected to the third wall and the fourth wall; the first wall, the second wall, the third wall, and the fourth wall are connected to the bottom wall and form the first space;
the heat sink is sealingly connected to surfaces of the first wall, the second wall, the third wall, and the fourth wall; and the third direction is perpendicular to both the second direction and the first direction.

6. The battery module according to claim 5, wherein the first channel comprises a first opening facing the second housing, the heat sink comprises a first surface and a second surface disposed opposite to each other along the first direction, the second surface faces the cell assembly; and along a direction opposite to the first direction, a position of the first opening does not exceed the first surface.

7. The battery module according to claim 6, wherein the first channel comprises a first segment and a second segment in communication along the first direction, the first segment comprises a first end and a second end disposed along the first direction, the second end is in communication with the second segment, the first opening is disposed at the first end; and along the second direction, a width W1 of the first segment is smaller than a width W2 of the second segment.

8. The battery module according to claim 7, further comprising a first insulator, at least a part of the first insulator is disposed in a second gap between the heat sink and the cell assembly; and along the first direction, the second end protrudes beyond the first insulator.

9. The battery module according to claim 8, wherein along the third direction, the first channel comprises a second opening facing the heat sink, the battery module further comprises a first separator, the first separator covers at least a part of the second opening; and along the first direction, an end portion of the first separator protrudes beyond the first insulator.

10. The battery module according to claim 9, wherein the first housing comprises two opposing step surfaces, and the first separator is connected to the two step surfaces and covers at least a part of the first segment.

11. The battery module according to claim 10, wherein one side of the first separator is connected to the two step surfaces, and another side is connected to the heat sink.

12. The battery module according to claim 9, wherein the heat sink comprises a second accommodation space, and the second accommodation space penetrates the heat sink along the first direction;
the battery module further comprises a second insulator, and the second insulator is disposed in the second accommodation space and protrudes beyond the first surface; and
the first channel further comprises a third segment, the third segment and the first segment are in communication through the first opening, a part of the second insulator is disposed in the third segment, and the second insulator is spaced apart from the first opening.

13. The battery module according to claim 12, wherein the battery module further comprises a first electrical connection portion, the first electrical connection portion is connected to the cell assembly, and the first electrical connection portion passes through the second accommodation space.

14. The battery module according to claim 12, wherein along the second direction, a width of the third segment is greater than a width of the first segment.

15. The battery module according to claim 12, wherein the first segment comprises a first region and a second region, the first region is connected to the third segment, and the second region is connected to the first region and the second segment; and
along the third direction, a distance between the first region and the first separator is smaller than a distance between the second region and the first separator.

16. The battery module according to claim 4, wherein the bottom wall comprises a third region, the third region is connected to the first through hole, the third region is provided with an inclined surface, and the inclined surface is arranged to converge toward the first through hole.

17. The battery module according to claim 16, wherein the bottom wall comprises a fourth region, at least a part of the cell assembly is disposed in the fourth region; and along the first direction, the third region is farther from the cell assembly than the fourth region.

18. The battery module according to claim 2, wherein the first housing comprises a first connecting member connected to the bottom wall, the first connecting member comprises a support portion, and the bottom wall is disposed on the support portion; and
the first connecting member is provided with a second through hole, the second through hole penetrates the first connecting member along the first direction, and a part of the first filling member is disposed in the second through hole.

19. The battery module according to claim 18, wherein the first connecting member comprises a bottom surface, the bottom surface faces away from the bottom wall; and along the first direction, a third space is provided between the first filling member and the bottom surface.

20. An electric device comprising the battery module according to claim 1.
